(19) United States
(12) Patent Application Publication
(10) Pub. No.: US 2004/0239704 A1
(43) Pub. Date: Dec. 2, 2004

(54) Amplifier switching circuit with current hysteresis

(76) Inventor: Steve E. Soar, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/447,481

(22) Filed: May 28, 2003

(51) Int. Cl. B41J 29/38

(52) U.S. Cl. 347/5

(57) ABSTRACT

In an implementation, an amplifier switching circuit includes a transistor switch, a signal current input, and a current hysteresis circuit. The transistor switch can switch on to generate a logic high output of the amplifier switching circuit, and can switch off to generate a logic low output of the amplifier switching circuit. The signal current input provides an input current that periodically turns the transistor switch on and off, and the current hysteresis circuit drives the transistor switch through a transition state.

### BACKGROUND

Electrical signals generated by various electrical components in an electronic device, or external to the electronic device, can result in unwanted electrical signal noise that can effect the reliability of logic level detection circuits in the electronic device. For example, electrical DC motors and encoders can be utilized for position control of a moveable component within the electronic device. In an implementation, a digital ASIC can be implemented to keep track of the position of the moveable component and to provide position feedback to a servo system for motion control of the component.

The digital ASIC can receive a series of logic pulses (e.g., logic high and/or logic low pulses) which correspond to the rotation of a drive motor. An encoder circuit can be implemented to operate as a switch that provides the logic high and logic low encoder signals to the digital ASIC. The logic high encoder signals are amplified enough to be greater than the logic threshold of the digital ASIC and to be determined as logic high encoder signals. Transitions between logic high and logic low signals can be counted to determine the distance of rotation of the drive motor.

The unwanted electrical signal noise may be picked up by the encoder circuit and transferred to the digital ASIC along with the encoder signal. The signal noise can then be output as the encoder signal, or as a component of the encoder signal, that is received by the digital ASIC and interpreted as multiple false logic state transitions. When the false transitions are detected by the digital ASIC, a motor positional error can occur which causes a drive motor position error. While conventional filtering techniques may be employed to filter the unwanted signal noise and may help to reduce the incidence of false transitions, the filtering does not adequately address the problem of a noise corrupted encoder signal that is detected as multiple false logic state transitions.

### SUMMARY

An amplifier switching circuit with current hysteresis is described herein.

In an implementation, an amplifier switching circuit includes a transistor switch, a signal current input, and a current hysteresis circuit. The transistor switch can switch on to generate a logic high output of the amplifier switching circuit, and can switch off to generate a logic low output of the amplifier switching circuit. The signal current input provides an input current that periodically turns the transistor switch on and off, and the current hysteresis circuit drives the transistor switch through a transition state.

### BRIEF DESCRIPTION OF THE DRAWINGS

The same numbers are used throughout the drawings to reference like features and components.

FIG. 1 illustrates an exemplary amplifier switching circuit with current hysteresis.

FIG. 2 illustrates an exemplary output and timing diagram of the amplifier switching circuit with current hysteresis shown in FIG. 1.

FIG. 3 illustrates another exemplary output and timing diagram of the amplifier switching circuit with current hysteresis shown in FIG. 1.

FIG. 4 is a flow diagram that illustrates an exemplary method for an amplifier switching circuit with current hysteresis.

FIG. 5 is a flow diagram that illustrates an exemplary method to configure an amplifier switching circuit with current hysteresis.

FIG. 6 illustrates various components of an exemplary printing device in which an amplifier switching circuit with current hysteresis can be implemented.

### DETAILED DESCRIPTION

The following describes an amplifier switching circuit with current hysteresis that provides an encoder signal which can be determined to correspond to a logic high or logic low state transition, and which is substantially unaffected by unwanted electrical signal noise. The amplifier switching circuit includes components to generate a hysteresis current that forces the transistor switch of the circuit to switch quickly and completely from one logic state to the next, thus avoiding mid-state output voltages. The amplifier switching circuit described herein replaces less effective noise filtering techniques and software recovery solutions with relatively low-cost, electronic components. Applications of the amplifier switching circuit and the techniques described herein include a frequency counter, a digital micrometer, a system to measure length, position, or angular motion, and/or any other circuit that generates a signal having detectable transitions which may be adversely effected by unwanted electrical signal noise.

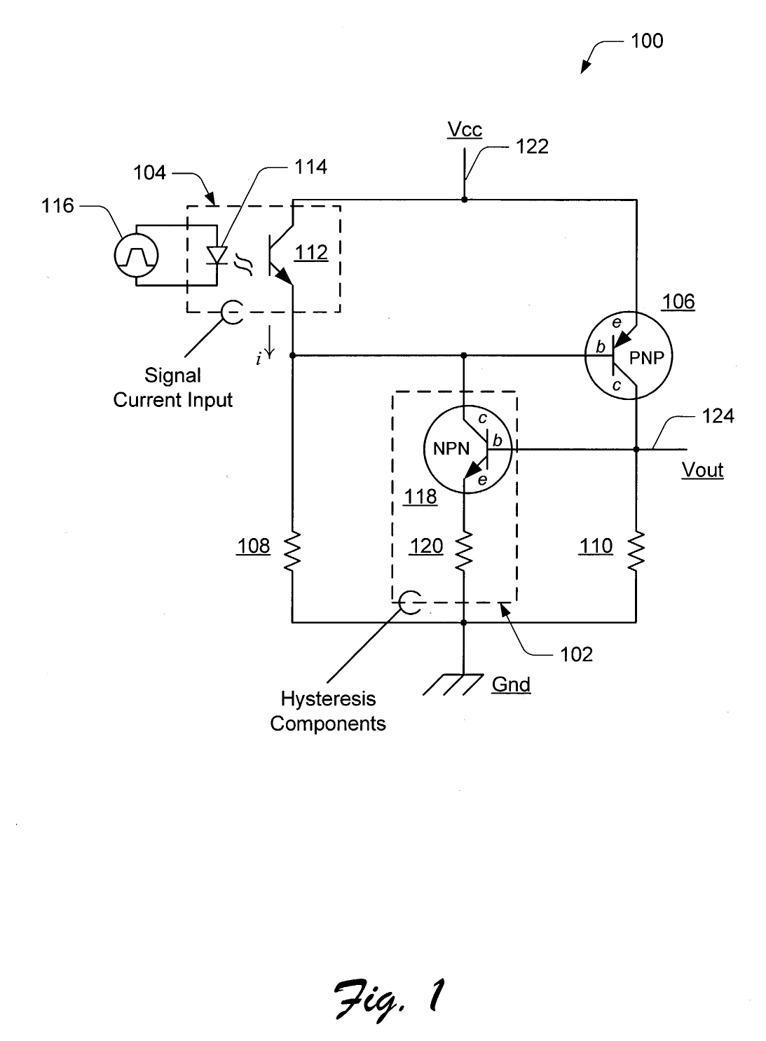

FIG. 1 illustrates an exemplary amplifier switching circuit 100 with current hysteresis components 102. The circuit 100 also includes a signal current input 104, a transistor switch 106, and two resistors 108 and 110. In this example, the signal current input 104 is implemented with a phototransistor 112, an LED 114, and an interrupting device, such as an encoder, between the phototransistor 112 and the LED 114. In practice, the signal current input 104 can be implemented with phototransistors, photodiodes, cadmium cells, hall devices, giant magnetoresistive (GMR) devices, as the output of another amplifier circuit, or as any other type of signal current input.

In amplifier switching circuit 100, a current pulse generation device 116 is shown as a consistent, or regulated, square wave input to LED 114 to simulate periodic illumination of LED 114 which is detected by phototransistor 112. In practice, a fixed current can be applied to illuminate LED 114 and an encoder disc can be rotated, or an encoder strip can be translated, in a gap between the LED 114 and the phototransistor 112 to periodically interrupt the light detected by the phototransistor 112. An encoder disc or encoder strip can be molded, stamped, photo etched, milled, or chemically machined, for example, and can be incorporated within a device that includes the phototransistor 112 and the LED 114. Alternatively, the encoder can be implemented as an array of magnetic poles and a magnetic field detector (e.g., a coil or hall device).

The hysteresis components 102 include a transistor 118 and a resistor 120. The transistor switch 106 and the hysteresis components transistor 118 can be implemented with commonly available general purpose PNP and NPN transistors, respectively. Alternatively, the transistor switch 106 and the transistor 118 can be implemented with PMOS and NMOS transistors, respectively. The circuit can also be implemented in its electronic dual with an NPN transistor implemented as the transistor switch 106 and a PNP transistor implemented as the hysteresis device transistor 118.

The base of transistor switch 106 is coupled to the emitter of phototransistor 112, to the collector of transistor 118, and to resistor 108 which is a 100K ohm resistor in this example. The emitter of transistor 118 is coupled to resistor 120 which is a 15K ohm resistor in this example. The collector of transistor switch 106 is coupled to the base of transistor 118 and to resistor 110 which is a 1K ohm resistor in this example. Each of the resistors 108, 110, and 120 are also coupled to ground. Other resistor values can be implemented that correspond to the current output of the signal device used, and to set the amount of hysteresis current desired.

A power supply voltage 122 (Vcc) is applied to the emitter of transistor switch 106 and to the collector of the phototransistor 112. In this example, Vcc 122 is +3.3 volts, however any input voltage can be implemented with the resistors 108, 110, and 120 in circuit 100 which can be similarly ratioed to accommodate a larger or smaller input voltage. In an electronic component, such as a printing device for example, Vcc 122 can be derived internally in the electronic component. An output voltage 124 (Vout) is determined at the collector of transistor switch 106.

In an implementation, amplifier switching circuit 100 can be electrically coupled as part of a closed-loop feedback system for positioning a service station in a printing device. For example, an inkjet printer includes one or more print cartridges that each have a printhead arranged to selectively apply an imaging medium such as liquid ink or toner to a print media in response to receiving print data corresponding to a print job. During printing, residual imaging medium tends to build up at nozzle orifices in a printhead which can partially or completely block the nozzles and degrade print quality. The printer can be implemented with a service station having wipers to clean and preserve the functionality of the printhead. The service station is typically moved into position to clean the printhead when a print job is initiated and before applying the imaging medium onto the print media.

Electrical DC motors and encoders can be utilized for service station position control within the printer to move and store the printhead after a printing operation. In one implementation, a digital ASIC can be implemented to keep track of the service station position and to provide position feedback to a servo system for service station motion control. The digital ASIC receives a series of logic pulses (e.g., logic high and/or logic low pulses, such as Vout 124) which correspond to the rotation of the service station drive motor.

The rotation of the drive motor rotates the encoder disc, or translates the encoder strip, in between an LED and phototransistor of an encoder circuit. The output of the encoder circuit, such as signal current 104, can then be input to an amplifier circuit that provides the logic high and logic low encoder signals to the digital ASIC. The encoder disc rotates, or the encoder strip translates, to alternately block light that is emitted by the LED which is detected by the phototransistor. The alternating light detection generates the signal current that switches the amplifier circuit on and/or off to provide the logic high and/or logic low transition signal outputs. These transitions can then be counted to determine the distance of rotation of the service station drive motor.

Various electrical noises can be generated by other electrical components operating in a printing device, or external to the printing device. Typically, the largest noise sources in a printing device are the drive circuits for the printer motors such as the paper feed motor, the carriage drive motor, and the service station drive motor. These unwanted electrical signal noises can be picked up by the encoder circuit and transferred to the digital ASIC along with the service station encoder signal. When the motor that provides service station position control is driving the service station, the unwanted electrical signal noises carried along with the encoder signal do not adversely affect the digital ASIC determining logic high or logic low service station position indications because they are small when compared to a complete logic level change.

In a conventional printing device, however, a service station stall or position error caused by the additional electrical noise can occur when the service station motor stops such that the encoder disc or the encoder strip is half occluding the photo sensor of the LED and phototransistor pair. When the encoder disc or strip is aligned such that a transistor amplifier circuit is biased mid-point, the circuit no longer switches to provide the logic high and/or logic low encoder signals. Rather, the encoder circuit operates as an amplifier that amplifies and outputs the unwanted electrical signal noise as the encoder signal. The digital ASIC receives and interprets the noise corrupted encoder signal as multiple false logic state transitions. When the false transitions are detected by the digital ASIC, a positional error occurs which causes a service station position error.

While filtering the unwanted signal noise may help to reduce the incidence of false transitions, the filtering does not adequately address the problem of a half-occluded encoder causing a noise corrupted encoder signal that is detected as multiple false logic state transitions. Furthermore, software solutions and recovery techniques are only implemented to recover from a service station stall or position error after having been detected which results in lost printing time and decreases the printing speed of the printer.

The amplifier switching circuit 100 can be implemented in a printing device to substantially eliminate the effects of unwanted electrical signal noise when generating the encoder signal Vout 124 which can be determined to correspond to a logic high or logic low state transition. A service station in an inkjet printer, for example, is positioned with a servo motor and a logic high or logic low signal 124 can be correlated to a position of the service station. A molded encoder disc implemented as part of the signal current input components 104 provides motor revolution counts (e.g., the Vout 124 encoder signal) that the digital ASIC registers as logic state transitions to determine how far the servo motor has turned which correlates to the position of the service station.

When phototransistor 112 is turned off and there is no current output at the emitter of the phototransistor 112, then transistor switch 106 is switched on because the base of transistor switch 106 is pulled down by resistor 108 and Vout 124 corresponds to a logic high value. In this example, Vout 124 is approximately +3.3 volts if Vcc is +3.3 volts and transistor switch 106 is switched on. When phototransistor 112 is turned on, a current is generated through the parallel combination of resistors 108 and 120 which raises the voltage at the base of transistor switch 106 until the transistor is switched off and Vout 124 corresponds to a logic low value.

The hysteresis components 102 facilitate driving the transistor switch 106 on and off as the signal current input 104 from phototransistor 112 increases and decreases through the on-to-off and off-to-on transition states of transistor switch 106. The hysteresis components 102 prevent the amplifier switching circuit 100 from being biased at a mid-point that would allow electrical noise to be interpreted as a logic transition, such as by a digital ASIC that receives the encoder signal 124.

When phototransistor 112 is turned off and the current output at the emitter of the phototransistor 112 decreases, transistor switch 106 is switched on, and Vout 124 corresponds to a logic high value. When Vout 124 is increasing, transistor 118 is also switched on which provides that some of the current is also drawn through the hysteresis components 102 such that transistor switch 106 will quickly switch on at the transition state and further provide an input to the base of transistor 118. This positive feedback causes the amplifier to rapidly switch through the transition region. In this example, the current through transistor 118 is determined by (Vcc−0.7 v)/resistor 120, and is a hysteresis current that is added to the base current of transistor switch 106.

When phototransistor 112 is turned on and the current output at the emitter of the phototransistor 112 increases (from zero to a maximum), transistor switch 106 is switched off, and Vout 124 corresponds to a logic low value. When Vout 124 is decreasing, transistor 118 is switched off and there is no current through the hysteresis components 102 which reduces the base current of transistor switch 106 such that transistor switch 106 will quickly switch off at the transition state. When transistor 118 switches off, any additional current that was being drawn through resistor 120 is stopped and transistor switch 106 quickly switches off because the additional current that was holding the base of transistor switch 106 down disappears.

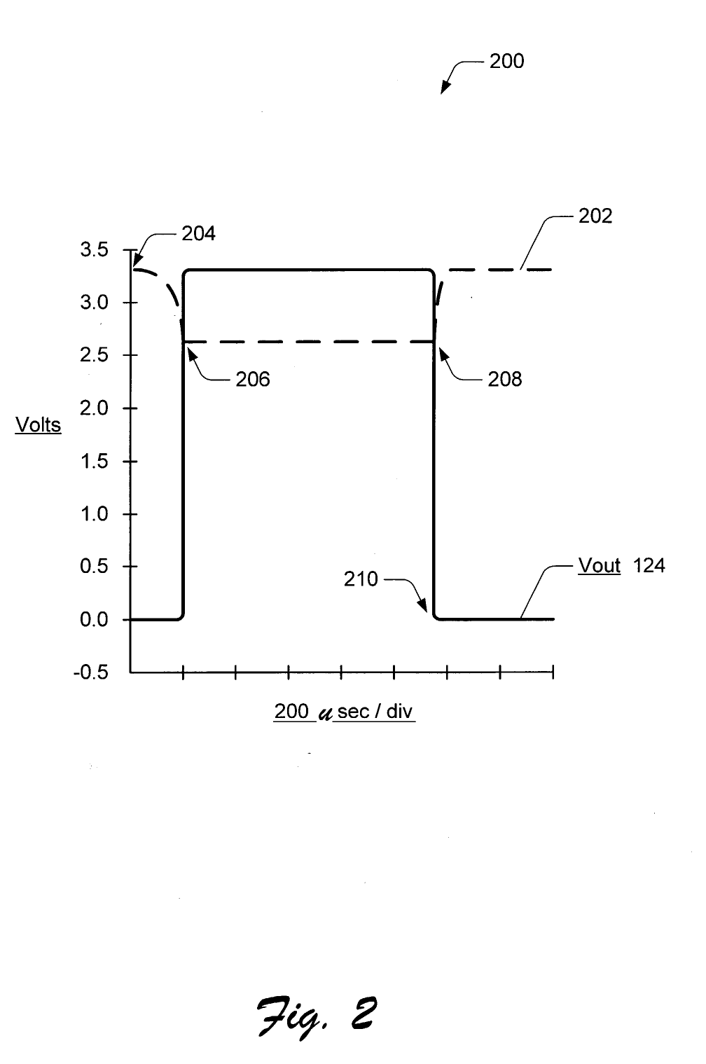

FIG. 2 illustrates an exemplary output and timing diagram 200 of the amplifier switching circuit 100 with current hysteresis 102 shown in FIG. 1. Diagram 200 shows the correlation between a voltage 202 at the base of transistor switch 106 (FIG. 1) and Vout 124 over time which, in this example, is 200 μsec/division of the diagram.

At a time zero (identifier 204), voltage 202 at the base of transistor switch 106 is approximately +3.3 volts (e.g., Vcc 122) and Vout 124 is approximately zero volts. When phototransistor 112 is turned off and the current output at the emitter of the phototransistor 112 decreases, the voltage 202 drops approximately 7/10 of a volt below Vcc 122 (e.g., approximately +2.6 volts at identifier 206). When voltage 202 reaches the transition point at +2.6 volts (identifier 206), transistor switch 106 is switched on and Vout 124 increases nearly instantaneously (due to the hysteresis components 102) from zero volts to approximately +3.3 volts (e.g., Vcc 122) which corresponds to a logic high value.

When phototransistor 112 is turned on and the current output at the emitter of the phototransistor 112 begins to increase (at identifier 208), the voltage 202 increases to Vcc 122 (e.g., approximately +3.3 volts in this example). At the transition point 208, transistor switch 106 is switched off and Vout 124 decreases nearly instantaneously (due to the hysteresis components 102) from +3.3 volts to approximately zero volts (at identifier 210) which corresponds to a logic low value.

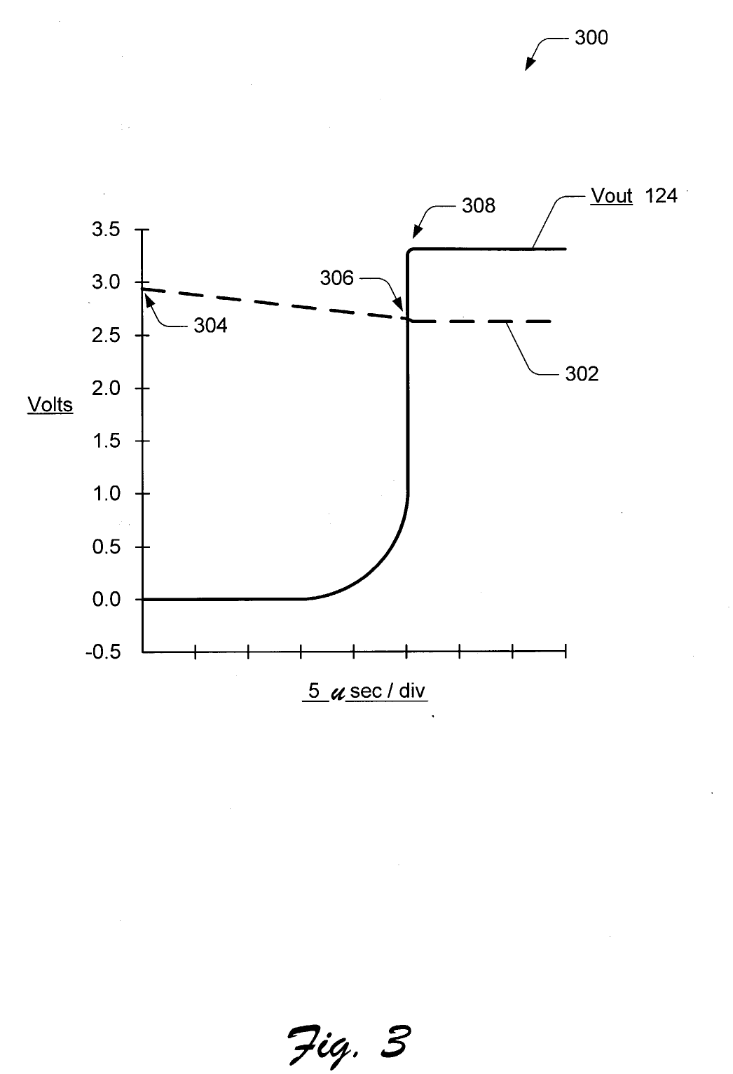

FIG. 3 illustrates another exemplary output and timing diagram 300 of the amplifier switching circuit 100 with current hysteresis 102 shown in FIG. 1. Diagram 300 shows the correlation between a voltage 302 at the base of transistor switch 106 (FIG. 1) and Vout 124 over time which, in this example, is 5 μsec/division of the diagram.

At a time zero (identifier 304), voltage 302 at the base of transistor switch 106 is approximately +2.9 volts and Vout 124 is zero volts. As voltage 302 decreases to approximately +2.6 volts at a transition point 306 which is approximately 7/10 of a volt below Vcc 122 (e.g., approximately +3.3 volts), transistor switch 106 is switched on and Vout 124 increases nearly instantaneously from zero volts to approximately +3.3 volts (e.g., Vcc 122 at identifier 308 which corresponds to a logic high value).

Diagram 300 shows that even with a slowly decreasing voltage 302 at the base of transistor switch 106 (approximately +2.9 to +2.6 volts over approximately 25 μsec), Vout increases nearly instantaneously from zero volts to Vcc 122 (approximately +3.3 volts in this example).

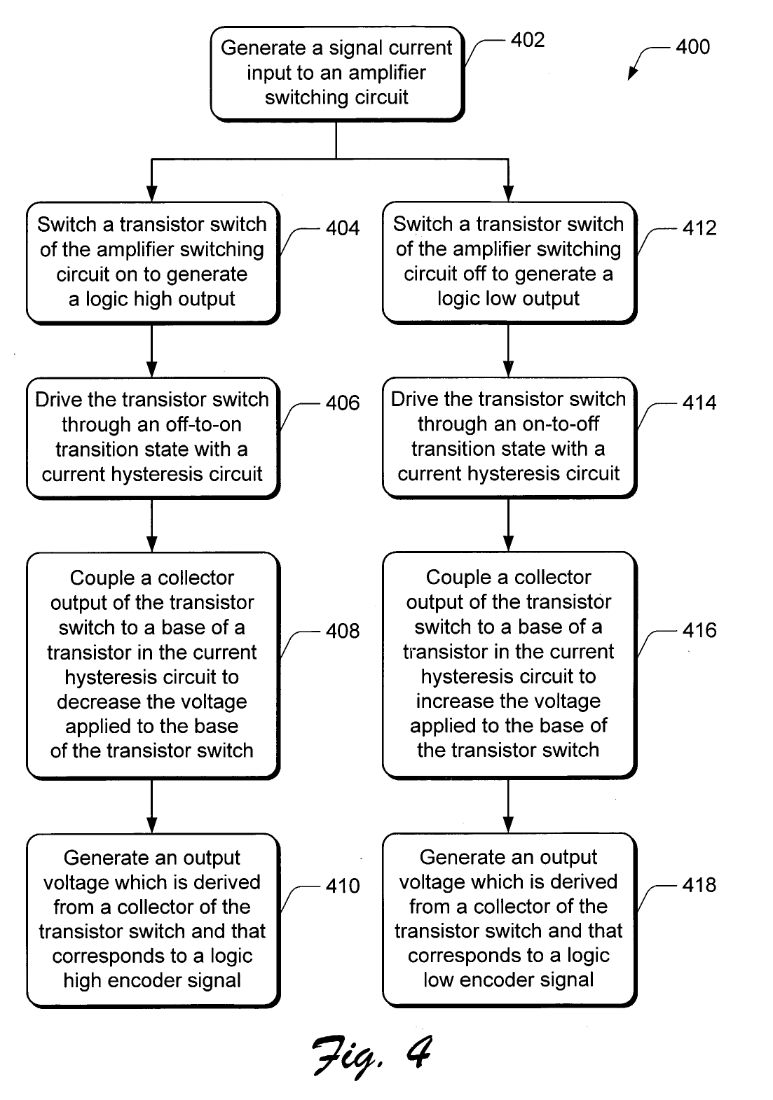

FIG. 4 illustrates a method 400 for an amplifier switching circuit with current hysteresis. The order in which the method is described is not intended to be construed as a limitation, and any number of the described method blocks can be combined in any order to implement the method.

At block 402, a signal current input to an amplifier switching circuit is generated. For example, the signal current input 104 (FIG. 1) can be generated with an LED 114, an encoder disc, and a phototransistor 112. The signal current input can be generated to correspond to motor revolutions that correlate to a position of a printhead service station in a printing device, for example. Further, the signal current input can be generated to correspond to revolutions of a service station position drive motor.

At block 404, a transistor switch of the amplifier switching circuit is switched on to generate a logic high output. For example, transistor switch 106 (FIG. 1) can be switched on to generate Vout 124 which corresponds to a logic high output. At block 406, the transistor switch is driven through an off-to-on transition state with a current hysteresis circuit. For example, transistor 118 (FIG. 1) is electrically coupled to resistor 120 and to transistor switch 106. Transistor 118 and resistor 120 form a current hysteresis circuit 102 that drives transistor switch 106 to preclude a mid-state logic output of the amplifier switching circuit 100.

At block 408, a collector output of the transistor switch is coupled to a base of a transistor in the current hysteresis circuit. When transistor switch 106 (FIG. 1) is switched on, transistor 118 is switched on to drive transistor switch 106 through the off-to-on transition state 206 (FIG. 2) by decreasing the voltage applied to a base of the transistor switch 106. At block 410, an output voltage is generated which is derived from a collector of the transistor switch. For example, Vout 124 (FIG. 1) is derived from the collector of transistor switch 106 and corresponds to a logic high encoder signal.

An alternative to blocks 404 through 410 are blocks 412 through 418. At block 412, the transistor switch of the amplifier switching circuit is switched off to generate a logic low output. For example, transistor switch 106 (FIG. 1) can be switched off to generate Vout 124 which corresponds to a logic low output. At block 414, the transistor switch is driven through an on-to-off transition state with the current hysteresis circuit. For example, transistor 118 (FIG. 1) is electrically coupled to resistor 120 and to transistor switch 106. Transistor 118 and resistor 120 together form the current hysteresis circuit 102 that drives transistor switch 106 to preclude a mid-state logic output of the amplifier switching circuit 100.

At block 416, a collector output of the transistor switch is coupled to the base of the transistor in the current hysteresis circuit. When transistor switch 106 (FIG. 1) is switched off, transistor 118 is switched off to drive transistor switch 106 through the on-to-off transition state 208 (FIG. 2) by increasing the voltage applied to a base of the transistor switch 106. At block 418, an output voltage is generated which is derived from a collector of the transistor switch. For example, Vout 124 (FIG. 1) is derived from the collector of transistor switch 106 and corresponds to a logic low encoder signal.

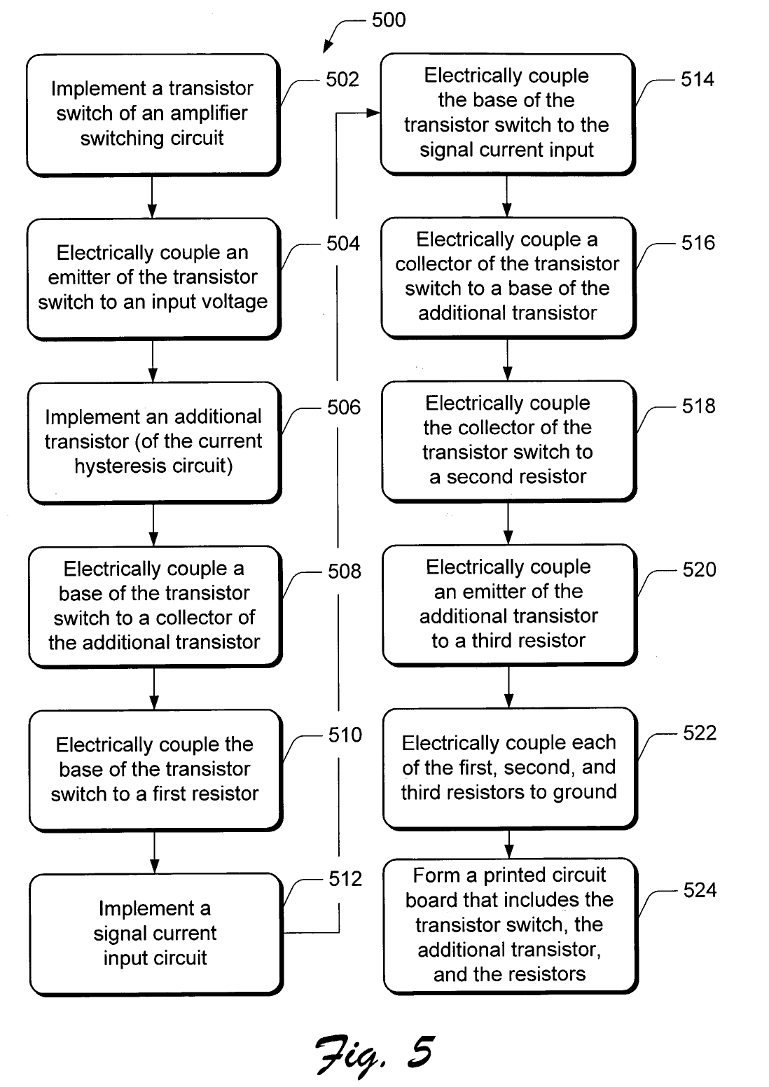

FIG. 5 illustrates a method 500 to configure an amplifier switching circuit with current hysteresis. The order in which the method is described is not intended to be construed as a limitation, and any number of the described method blocks can be combined in any order to implement the method.

At block 502, a transistor switch of the amplifier switching circuit is implemented. For example, transistor switch 106 (FIG. 1) can be implemented as a PNP transistor. At block 504, an emitter of the transistor switch is electrically coupled to an input voltage. For example, the emitter of transistor switch 106 is electrically coupled to Vcc 122.

At block 506, a transistor (i.e., which is in addition to the transistor switch) of the current hysteresis circuit is implemented. For example, transistor 118 (FIG. 1) of the hysteresis components 102 can be implemented as an NPN transistor. At block 508, a base of the transistor switch is electrically coupled to a collector of the additional transistor. For example, the base of transistor switch 106 is electrically coupled to the collector of transistor 118.

At block 510, the base of the transistor switch is electrically coupled to a first resistor. For example, the base of transistor switch 106 is electrically coupled to resistor 108. At block 512, a signal current input circuit is implemented. For example, signal current input 104 (FIG. 1) is implemented with a circuit that includes LED 114, an encoder disc, and phototransistor 112. At block 514, the base of the transistor switch is electrically coupled to the signal current input. For example, the base of transistor switch 106 is electrically coupled to the signal current input 104.

At block 516, a collector of the transistor switch is electrically coupled to a base of the additional transistor. For example, the collector of transistor switch 106 is electrically coupled to the base of transistor 118. At block 518, the collector of the transistor switch is electrically coupled to a second resistor. For example, the collector of transistor switch 106 is electrically coupled to resistor 110.

At block 520, an emitter of the additional transistor is electrically coupled to a third resistor. For example, the emitter of transistor 118 is electrically coupled to resistor 120 which together forms the hysteresis components 102. At block 522, each of the first resistor, second resistor, and third resistor are electrically coupled to ground. For example, resistor 108, resistor 110, and resistor 120 are all electrically coupled to ground (i.e., “Gnd”).

At block 524, a printed circuit board is formed that includes the transistor switch, the additional transistor, and each of the first resistor, second resistor, and third resistor.

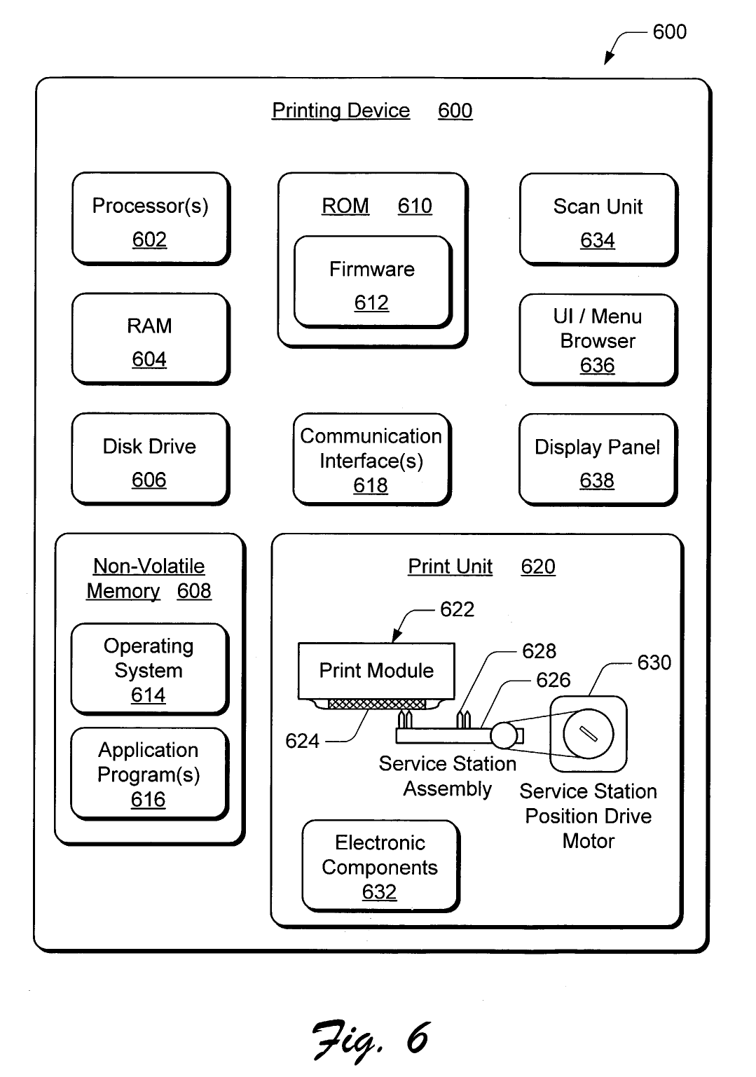

FIG. 6 illustrates various components of an exemplary printing device 600 in which the amplifier switching circuit 100 with current hysteresis 102 shown in FIG. 1 can be implemented. General reference is made herein to one or more printing devices, such as printing device 600. As used herein, “printing device” means any electronic device having data communications, data storage capabilities, and/or functions to render printed characters, text, graphics, and/or images on a print media. A printing device may be a printer, fax machine, copier, plotter, and the like. The term “printer” includes any type of printing device using a transferred imaging medium, such as ejected ink, to create an image on a print media. Examples of such a printer can include, but are not limited to, inkjet printers, electrophotographic printers, plotters, portable printing devices, as well as all-in-one, multi-function combination devices.

Printing device 600 includes one or more processors 602 (e.g., any of microprocessors, controllers, and the like) which process various instructions to control the operation of printing device 600 and to communicate with other electronic and computing devices.

Printing device 600 can be implemented with one or more memory components, examples of which include random access memory (RAM) 604, a disk drive 606, and non-volatile memory 608 (e.g., any one or more of a ROM 610, flash memory, EPROM, EEPROM, etc.). The one or more memory components store various information and/or data such as configuration information, print job information and data, graphical user interface information, fonts, templates, menu structure information, and any other types of information and data related to operational aspects of printing device 600.

Printing device 600 includes a firmware component 612 that is implemented as a permanent memory module stored on ROM 610, or with other components in printing device 600, such as a component of a processor 602. Firmware 612 is programmed and distributed with printing device 600 to coordinate operations of the hardware within printing device 600 and contains programming constructs used to perform such operations.

An operating system 614 and one or more application programs 616 can be stored in non-volatile memory 608 and executed on processor(s) 602 to provide a runtime environment. A runtime environment facilitates extensibility of printing device 600 by allowing various interfaces to be defined that, in turn, allow application programs 616 to interact with printing device 600.

Printing device 600 further includes one or more communication interfaces 618 which can be implemented as any one or more of a serial and/or parallel interface, a wireless interface, any type of network interface, and as any other type of communication interface. A wireless interface enables printing device 600 to receive control input commands and other information from an input device, such as from an infrared (IR), 802.11, Bluetooth, or similar RF input device. A network interface provides a connection between printing device 600 and a data communication network which allows other electronic and computing devices coupled to a common data communication network to send print jobs, menu data, and other information to printing device 600 via the network. Similarly, a serial and/or parallel interface provides a data communication path directly between printing device 600 and another electronic or computing device.

Printing device 600 also includes a print unit 620 that includes mechanisms arranged to selectively apply an imaging medium such as liquid ink, toner, and the like to a print media in accordance with print data corresponding to a print job. For example, print unit 620 includes a print module 622, or cartridge, that has a printhead 624 to apply the imaging medium to the print media. A service station assembly 626 includes wipers 628 to clean printhead 624 and remove imaging medium (e.g., ink) residue and contaminants. A service station position drive motor 630 is operably connected to position the service station assembly 626 to clean printhead 624. The print media can include any form of media used for printing such as paper, plastic, fabric, Mylar, transparencies, and the like, and different sizes and types such as 8½×11, A4, roll feed media, etc. Print unit 620 also includes various electronic components 632 such as one or more ASICs and the amplifier switching circuit 100 with current hysteresis 102 shown in FIG. 1.

Printing device 600, when implemented as an all-in-one device for example, can also include a scan unit 634 that can be implemented as an optical scanner to produce machine-readable image data signals that are representative of a scanned image, such as a photograph or a page of printed text. The image data signals produced by scan unit 634 can be used to reproduce the scanned image on a display device or with a printing device.

Printing device 600 also includes a user interface and menu browser 636 and a display panel 638. The user interface and menu browser 636 allows a user of printing device 600 to navigate the device's menu structure. User interface 636 can be indicators or a series of buttons, switches, or other selectable controls that are manipulated by a user of the printing device. Display panel 638 is a graphical display that provides information regarding the status of printing device 600 and the current options available to a user through the menu structure.

Although shown separately, some of the components of printing device 600 can be implemented in an application specific integrated circuit (ASIC). Additionally, a system bus (not shown) typically connects the various components within printing device 600. A system bus can be implemented as one or more of any of several types of bus structures, including a memory bus or memory controller, a peripheral bus, an accelerated graphics port, or a local bus using any of a variety of bus architectures.

Although embodiments of the invention have been described in language specific to structural features and/or methods, it is to be understood that the invention defined in the appended claims is not necessarily limited to the specific features or methods described. Rather, the specific features and methods are disclosed as exemplary implementations of the claimed invention.

1. An amplifier switching circuit, comprising:
a transistor switch configured to switch on to generate a logic high output of the amplifier switching circuit, and further configured to switch off to generate a logic low output of the amplifier switching circuit;
a signal current input configured to provide an input current that periodically turns the transistor switch on and off; and
a current hysteresis circuit configured to drive the transistor switch through a transition state to preclude a mid-state logic output of the amplifier switching circuit, the current hysteresis circuit formed with an additional transistor electrically coupled to a resistor and electrically coupled to the transistor switch.

2. An amplifier switching circuit as recited in claim 1, wherein a base of the additional transistor receives a collector output of the transistor switch such that when the transistor switch is on, the additional transistor is switched on to draw current through the resistor and decrease the voltage applied to a base of the transistor switch.

3. An amplifier switching circuit as recited in claim 1, wherein a base of the additional transistor receives a collector output of the transistor switch such that when the transistor switch is off, the additional transistor is switched off to increase the voltage applied to a base of the transistor switch.

4. An amplifier switching circuit as recited in claim 1, wherein:
an emitter of the transistor switch is electrically coupled to an input current;
a base of the transistor switch is electrically coupled to a collector of the additional transistor, electrically coupled to a second resistor, and electrically coupled to the signal current input;
a collector of the transistor switch is electrically coupled to a base of the additional transistor and electrically coupled to a third resistor;
an emitter of the additional transistor is electrically coupled to the resistor; and
each of the resistor, second resistor, and third resistor are electrically coupled to ground.

5. An amplifier switching circuit as recited in claim 1, wherein the signal current input is generated with a controlled current input circuit.

6. An amplifier switching circuit as recited in claim 1, wherein the signal current input is generated with an LED, an encoder, and a phototransistor.

7. An amplifier switching circuit as recited in claim 1, wherein the signal current input is a phototransistor output.

8. An amplifier switching circuit as recited in claim 1, wherein the signal current input is a position indication of a drive motor in a printing device.

9. An amplifier switching circuit as recited in claim 1, wherein the signal current input includes transitions that correspond to position transitions of a moveable component in a printing device.

10. An amplifier switching circuit as recited in claim 1, wherein the signal current input corresponds to a number of revolutions of a motor.

11. An amplifier switching circuit as recited in claim 1, wherein the signal current input corresponds to motor revolutions that correlate to a position of a printhead service station in a printing device.

12. An amplifier switching circuit as recited in claim 1, further comprising an output voltage that is determined at a collector of the transistor switch, the output voltage corresponding to at least one of a logic high and a logic low encoder signal.

13. A printed circuit board comprising the amplifier switching circuit as recited in claim 1.

14. A printing device comprising the amplifier switching circuit as recited in claim 1.

15. A printing device, comprising:
a printhead configured to apply an imaging medium to a print media;
a service station configured to clean the printhead;
a service station position drive motor configured to position the service station; and
an amplifier switching circuit with current hysteresis configured to generate a logic encoder signal that corresponds to a position of the service station, the current hysteresis being generated with a current hysteresis circuit configured to drive a transistor switch of the amplifier switching circuit through a transition state to preclude a mid-state logic encoder signal, the current hysteresis circuit formed with an additional transistor electrically coupled to a resistor and electrically coupled to the transistor switch.

16. A printing device as recited in claim 15, further comprising an ASIC configured to receive the logic encoder signal as an output voltage, and further configured to determine that the logic encoder signal corresponds to at least one of a logic high and a logic low encoder signal.

17. A printing device as recited in claim 15, wherein the amplifier switching circuit with current hysteresis is further configured to switch on to generate a logic high encoder signal, and is further configured to switch off to generate a logic low encoder signal.

18. A printing device as recited in claim 15, further comprising a signal current generator configured to provide an input current that periodically turns the transistor switch on and off.

19. A printing device as recited in claim 15, wherein a base of the additional transistor receives a collector output of the transistor switch such that when the transistor switch is on, the additional transistor is switched on to draw current through the resistor and decrease the voltage applied to a base of the transistor switch.

20. A printing device as recited in claim 15, wherein a base of the additional transistor receives a collector output of the transistor switch such that when the transistor switch is off, the additional transistor is switched off to increase the voltage applied to a base of the transistor switch.

21. A printing device as recited in claim 15, wherein:
an emitter of the transistor switch is electrically coupled to an input current;
a base of the transistor switch is electrically coupled to a collector of the additional transistor, electrically coupled to a second resistor, and electrically coupled to the signal current input;
a collector of the transistor switch is electrically coupled to a base of the additional transistor and electrically coupled to a third resistor;
an emitter of the additional transistor is electrically coupled to the resistor; and
each of the resistor, second resistor, and third resistor are electrically coupled to ground.

22. A printing device as recited in claim 18, wherein the signal current generator is a controlled current input circuit configured to generate the input current.

23. A printing device as recited in claim 18, wherein the signal current generator is formed with an LED, an encoder, and a phototransistor.

24. A printing device as recited in claim 18, wherein the signal current generator is configured to generate the input current as a position indication.

25. A printing device as recited in claim 18, wherein the signal current generator is configured to generate the input current to include transitions that correspond to position indications.

26. A printing device as recited in claim 18, wherein the signal current generator is configured to generate the input current to correspond to a number of revolutions of the service station position drive motor.

27. A method, comprising:
generating a signal current input to an amplifier switching circuit;
switching a transistor switch of the amplifier switching circuit on to generate a logic high output; and
driving the transistor switch through an off-to-on transition state with a current hysteresis circuit to preclude a mid-state logic output of the amplifier switching circuit, the current hysteresis circuit formed with an additional transistor electrically coupled to a resistor and electrically coupled to the transistor switch.

28. A method as recited in claim 27, further comprising:
switching the transistor switch off to generate a logic low output; and
driving the transistor switch through an on-to-off transition state with the current hysteresis circuit to preclude a mid-state logic output of the amplifier switching circuit.

29. A method as recited in claim 27, further comprising generating an output voltage that is determined at a collector of the transistor switch, the output voltage corresponding to a logic high encoder signal.

30. A method as recited in claim 28, further comprising generating an output voltage that is determined at a collector of the transistor switch, the output voltage corresponding to a logic low encoder signal.

31. A method as recited in claim 27, further comprising coupling a collector output of the transistor switch to a base of the additional transistor such that when the transistor switch is on, the additional transistor is switched on to drive the transistor switch through the off-to-on transition state by decreasing the voltage applied to a base of the transistor switch.

32. A method as recited in claim 28, further comprising coupling a collector output of the transistor switch to a base of the additional transistor such that when the transistor switch is off, the additional transistor is switched off to drive the transistor switch through the on-to-off transition state by increasing the voltage applied to a base of the transistor switch.

33. A method as recited in claim 27, wherein the signal current input is generated with a controlled current input circuit.

34. A method as recited in claim 27, wherein the signal current input is generated with an LED, an encoder, and a phototransistor.

35. A method as recited in claim 27, wherein the signal current input is generated to correspond to motor revolutions that correlate to a position of a printhead service station in a printing device.

36. A method as recited in claim 27, wherein the signal current input is generated to correspond to revolutions of a service station position drive motor.

37. A method to configure an amplifier switching circuit with current hysteresis, comprising:
electrically coupling an emitter of a transistor switch to an input current;
electrically coupling a base of the transistor switch to a collector of an additional transistor;
electrically coupling the base of the transistor switch to a first resistor;
electrically coupling the base of the transistor switch to a signal current input;
electrically coupling a collector of the transistor switch to a base of the additional transistor;
electrically coupling the collector of the transistor switch to a second resistor;
electrically coupling an emitter of the additional transistor to a third resistor; and
electrically coupling each of the first resistor, second resistor, and third resistor to ground.

38. A method as recited in claim 37, further comprising implementing an LED, an encoder, and a phototransistor to generate the signal current input.

39. A method as recited in claim 37, further comprising forming a printed circuit board that includes the transistor switch, the additional transistor, and each of the first resistor, second resistor, and third resistor.

40. A system, comprising:
means to generate a signal current input to an electronic circuit;
means to switch a transistor switch of the electronic circuit on to generate a logic high output; and
means to drive the transistor switch through an off-to-on transition state to preclude a mid-state logic output of the amplifier switching circuit.

41. A system as recited in claim 40, further comprising:
means to switch the transistor switch off to generate a logic low output; and
means to drive the transistor switch through an on-to-off transition state to preclude a mid-state logic output of the amplifier switching circuit.

42. A system as recited in claim 40, further comprising means to generate an output voltage that is determined at a collector of the transistor switch, the output voltage corresponding to a logic high encoder signal.

43. A system as recited in claim 40, further comprising means to generate an output voltage that is determined at a collector of the transistor switch, the output voltage corresponding to a logic low encoder signal.
